(19) United States
(12) Patent Application Publication
(10) Pub. No.: US 2018/0349847 A1
(43) Pub. Date: Dec. 6, 2018

(54) Inventory Management Method and System

(71) Applicant: Scott A. Nurick, Lafayette Hill, PA (US)

(72) Inventor: Scott A. Nurick, Lafayette Hill, PA (US)

(21) Appl. No.: 15/992,812

(22) Filed: May 30, 2018

Related U.S. Application Data
(60) Provisional application No. 62/514,012, filed on Jun. 2, 2017.

(51) Int. Cl. G06Q 10/08

(52) U.S. Cl. CPC G06Q 10/0875

(57) ABSTRACT

A method and system for generating and managing an inventory of assets. The method and system include receiving information identifying at least one building and receiving information identifying at least one location inside or outside the building. Information is received which identifies one or more assets located in the at least one location of the building. The method and system also includes identifying a date or dates for the receipt of the information with respect to the one or more assets. One or more assets is selected for creating a list, and the list is created.

### CROSS REFERENCE TO RELATED APPLICATIONS

The present application claims priority to provisional application No. 62/514,012 filed on Jun. 2, 2017 and the subject matter of provisional application No. 62/514,012 is incorporated by reference herein in its entirety.

### FIELD OF THE INVENTION

The present invention relates to an inventory management method and system which is accessible via mobile devices or other electronic devices such stationary computers to manage inventory contents of businesses and residences.

### BACKGROUND OF THE INVENTION

Homeowners and business owners would greatly benefit from having an organized record of their belongings in the event of loss or damage. For example, such a list can be used to file an insurance claim in the event of theft or flooding or fire, or even to secure insurance coverage in the first place. This list can also be used for estate planning to decide who will obtain the recorded items in the event of death.

It is difficult for homeowners to start and, importantly, finish and maintain an inventory of all of the items in their home as this may be a daunting task and the items in the home (whether a primary or secondary home) may vary over time as some items are obtained and others gotten rid of (or replaced) over time. The difficulties of creating and maintaining an inventory of tangible items is also an issue for business owners since the process has traditionally been burdensome and tedious for everyone.

Traditionally, homeowners and businesses have relied on paper lists, receipts, their own memory, and electronic lists to keep track of their belongings in the event of an emergency. It has also been known to take photos of items or personal property in homes or businesses to document what is owned and some software programs have been introduced to facilitate the recording and organizing of items and personal property. The antiquated method of taking photos, storing pictures on a disk drive etc. still subjects these parties to the same risk as these drives are often damaged, lost or not kept current.

However, in spite of the advances in record-keeping from paper lists to documentation assisted by software and digital photography, documentation of belongings continues to be a tedious task that is time-consuming and an activity which is not favored by homeowners, renters, and businesses. As a result, many homeowners, renters, and businesses have not documented what they own, which is risky in the event of loss since it is very difficult to create a list retroactively, especially in the event of theft or destruction of the items at issue. Accurate documentation also reduces risk of fraud to the insurance companies.

What is needed is an inventory management system which is easy and likely to be used by homeowners, renters, and businesses, and which has appropriate functionalities to allow successful creation, maintenance, and organization of inventory listings, as well as functionality for submission to third parties such as insurance companies.

### SUMMARY

In one aspect, the present invention is directed to a method for generating and managing an inventory of assets. The method includes receiving information identifying at least one building and receiving information identifying at least one location inside or outside the building. Information is received which identifies one or more assets located at the at least one location of the building. The method also includes identifying a date or dates for the receipt of the information with respect to the one or more assets. One or more assets is selected for creating a list, and the list is created. This list is accessible to the user for a number of purposes. The method can also include computing an aggregate value of a plurality of the one or more assets on the list based on the identifying information with respect to the one or more assets.

In another aspect, the present invention is directed to a system for generating and managing an inventory of assets. The system includes one or more processors (such as the processors in a computer such as a server) and a machine readable medium (such as a hard drive) including instructions stored therein (such as computer programs or “software” compiled into assembly language or machine language after creation in a programming language such as C++, Java, HTML, etc.). When the instructions from the machine readable medium are executed by the one or more processors, the processors can perform certain operations. The operations include receiving information identifying at least one building and receiving information identifying at least one location inside or outside of the building. The operations can also include receiving identifying information with respect to one or more assets located in the at least one location of the building. The operations can also include identifying a date or dates for the receipt of the information with respect to the one or more assets and selecting one or more of the assets for creating a list as well as creating the list. The operations can also include computing an aggregate value of a plurality of the one or more assets on the list based on the identifying information with respect to the one or more assets.

In yet another aspect, the present invention is directed to a method for claim submission for reimbursement to an insurance company. The method includes receiving information identifying at least one building. The method also can include receiving information identifying at least one location inside or outside a building and receiving identifying information with respect to one or more assets located in the at least one location of the building. The information with respect to the one or more assets includes image data containing images of the one or more assets. The method also includes identifying a date or dates for the receipt of the information with respect to the one or more assets and selecting one or more of the assets for creating a list. The list is created having the selected assets and includes at least some of the identifying information with respect to the one or more assets. The method also includes computing a value of the assets on the list of selected assets based on the identifying information with respect to the one or more assets. A claim for reimbursement is submitted to an insurance company for the loss or damage of assets at least partially included on the list of the selected assets. Also, the method involves sending to the insurance company, after the submission of the claim, a first electronic communication containing identifying information for the claim which was submitted as well as the list of selected assets and/or information to enable remote access by the insurance company to the list of the selected assets on a remote server. When an insurance company is given access to the list of selected assets, identifying information for the claim can be provided to the insurance company when information to enable access is provided and/or once the insurance company accesses the list of scheduled assets, identifying information for the claim is present on the website of the software application for the insurance company to see. The identifying information for the claim which was submitted can include the insurance company name and/or claim number and/or policy number and/or the filled out claim form itself and/or a receipt received upon electronic submission of the claim to an insurance company, etc. The list of selected assets which is accessible to the insurance company or which is sent via an electronic communication to the insurance company preferably includes values for individual assets on the list and at least one aggregate value for a plurality of the assets on the list. The method also includes identifying a date for when the electronic communication was sent to the insurance company. Also, the following is stored in one or more computer readable memory storage devices: the information which identifies at least one building, the information which identifies the at least one location the information identifying the one or more assets, the date or dates for receipt of the information with respect to the one or more assets, the information associated with the list of the selected assets, the list of the selected assets, and the date on which the electronic communication was sent to the insurance company. Preferably, all of the information is stored in a remote server on the “cloud” so none of the referenced drives are required by the user.

In another aspect, the present invention is directed to a system for claim submission for reimbursement from an insurance company for the loss or damage of assets at least partially included on a list of selected assets. The system has one or more processors and a machine readable medium including instructions stored therein. When the instructions are executed by the one or more processors, they cause the processors to perform a variety of operations. The operations include receiving information identifying at least one building. The operations can also include receiving information identifying at least one location inside or outside a building and receiving identifying information with respect to one or more assets located in the at least one location of the building. The information with respect to the one or more assets includes image data containing images of the one or more assets. The operations also encompass identifying a date or dates for the receipt of the information with respect to the one or more assets, selecting one or more of the assets for creating the list, and creating the list of the selected assets which includes at least some of the identifying information with respect to the one or more assets. The operations also include computing a value of the assets on the list of selected assets based on the identifying information with respect to the one or more assets. The operations also encompass sending to the insurance company, after the submission of the claim, a first electronic communication containing identifying information for the claim which was submitted as well as the list of selected assets and/or information to enable remote access by the insurance company to the list of the selected assets on a remote server. When an insurance company is given access to the list of selected assets, identifying information for the claim can be provided to the insurance company when information to enable access is provided and/or once the insurance company accesses the list of scheduled assets, identifying information for the claim is present on the website of the software application for the insurance company to see. The list of selected assets which is accessible to the insurance company or which is sent via an electronic communication to the insurance company preferably includes values for individual assets on the list and at least one aggregate value for a plurality of the assets on the list. The operations also include identifying a date for when the electronic communication was sent to the insurance company, and storing the information identifying the at least one building, information identifying the at least one location, the information identifying the one or more assets, the date or dates for receipt of the information with respect to the one or more assets, the information associated with the list of the selected assets, the list of the selected assets, and the date on which the electronic communication was sent to the insurance company, in one or more computer readable memory storage devices. This storage is preferably done on a remote server for security and accessibility purposes.

In another aspect, the present invention exhibits full customizability in that the user has discretion to name and/or take pictures and/or videos of properties, locations, and assets. Thus, the names of properties, locations, and assets are fully customizable and the user can arbitrarily choose them at the user's discretion. The descriptions of properties, locations, and assets are also fully customizable and the user can arbitrarily provide any descriptions at the user's discretion. Even what the locations and assets represent is fully customizable since a location can be a kitchen, or a safe, or a closet, or a jewelry box, or a category of items such as furniture, and an asset can be a couch or jewelry or a hardwood floor. It's really up to the user. Additionally, a user can choose whether to take photos and/or video and what locations and assets these photos and/or videos are associated with. More details of this customizability shall be explained further below.

### BRIEF DESCRIPTION OF THE DRAWINGS

FIG. 1 is directed to a network system which can be part of the present invention.

FIG. 2 is directed to an electronic system which can implement the present invention.

FIG. 3 is directed to the general steps of the present invention

FIG. 4 is directed to a flowchart showing the steps of the present invention

### DETAILED DESCRIPTION OF THE INVENTION

As stated above, in spite of advancements in record-keeping, creating and maintaining an inventory of items and personal property remains a challenge for homeowners, renters, businesses, and others. The present invention addresses these issues with a method and system that is easy to use, is accessible to mobile devices and computers, and combines lists with photos to facilitate the completion and maintenance of inventories for residences and businesses, as well as the ability to search assets and to submit information in connection with insurance claims and other activities, as explained below.

The detailed description set forth below is intended as a description of some, but not all, of the configurations of the subject technology and is not intended to represent an exhaustive list. The detailed description includes specific details for the purpose of providing a thorough understanding of the present invention and subject technology. The subject invention and technology is not limited to the specific details set forth herein and may be practiced without these specific details. In other instances, well-known structures and techniques have not been shown in detail so as not to obscure the disclosure.

Some embodiments and examples provided herein describe identifying and/or storing user property information. The stored user information may be encrypted to protect user security.

The disclosed system and method facilitate generation and maintenance of an inventory of personal property or belongings (e.g. contents such as furniture, electronics, home appliances, vehicles, bikes, bicycles, equipment, clothing, etc.) within a building such as a user dwelling or a place of business.

The present invention relies on a network of devices which are connected with one another, as more clearly defined below.

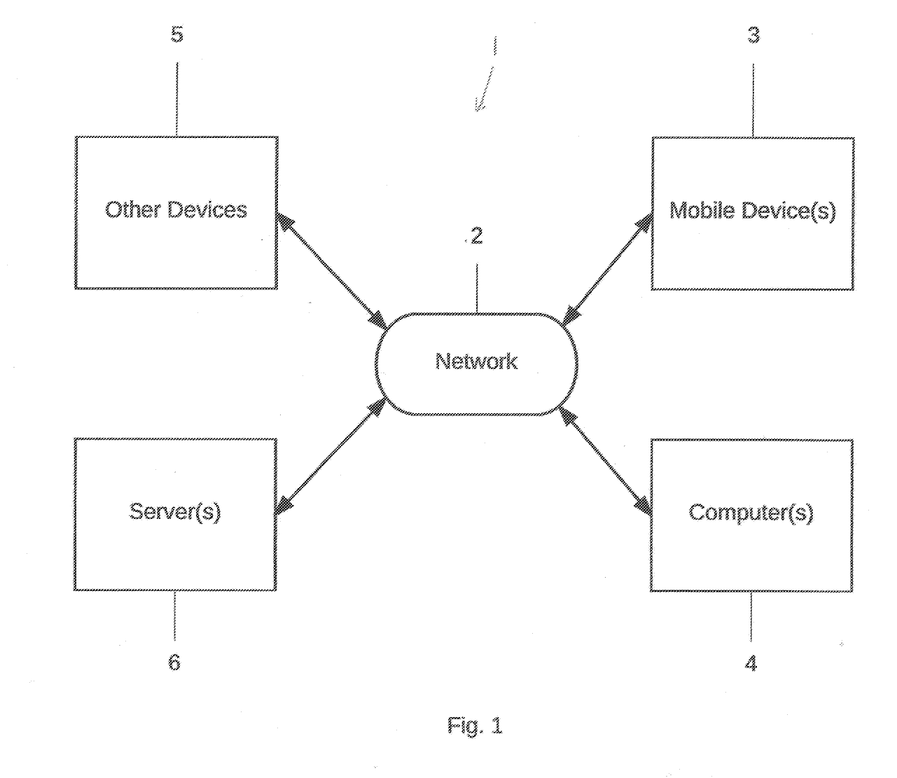

FIG. 1 illustrates an example of a network system 1, which provides for communication as envisioned by the present invention. The network system 1 may include a number of electronic devices (3, 4, 5) communicably connected to one or more servers 6, such as via a network 2. The connection between the servers 6 and the electronic devices (3, 4, 5) can be via a direct cable connection where the server is proximate to the electronic devices (3, 4, 5) or via a remote connection which can be a wired connection such as optic fiber, or it can be a wireless connection through the use of electromagnetic waves, or a combination. The servers 6 can be one or a combination of servers 6 which are local or remote, and wireless and/or hard wired. Preferably, the servers 6 are remote since they will be on the “cloud” for secure storage. Network 2 can be a public communication network (e.g., the Internet, cellular data network, dialup modems over a telephone network) or a private communications network (e.g., private LAN, leased lines). Further, network 2 can include, but is not limited to, any one or more of the following network topologies, including a bus network, a star network, a ring network, a mesh network, a star-bus network, a tree or hierarchical network, and the like.

The electronic devices can include computing devices such as one or more mobile devices 3, one or more desktop or laptop computers 4, or other devices 5 which are commonly connected in network systems. The electronic devices can include smartphones, personal digital assistants, portable media players, tablet computers, image capture devices (e.g., cameras or video recorders), or other appropriate computing devices. In some embodiments, the electronic devices have an image capturing capability and can be stand-alone cameras, or mobile devices with image capturing ability such as many smart phones. In FIG. 1, the mobile device 3 preferably is a smart phone. A desktop computer 4 can also be part of the network. Other devices 5 can include a personal digital assistant (PDA). There is no limitation on which devices can be part of the network 2.

In some aspects, server(s) 6 can be a single computing device such as a computer server. In other implementations, server(s) 2 can represent more than one computing device working together to perform the actions of a server computer (e.g., cloud computing). Server(s) 6 may be coupled with various remote databases or storage services. The functions performed by the server(s) 2 may be performed within a single server, or across multiple servers.

Communications between the various electronic devices (3, 4, 5, 6) may be facilitated through various communication protocols. In some aspects, the electronic devices may communicate wirelessly through a communication interface (not shown), which may include digital signal processing circuitry where necessary. The communication interface may provide for communications under various modes or protocols, including Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including using a Bluetooth, WiFi, or other such transceiver.

Users may interact with the network system 1 system hosted by one of the server(s) 6 and/or one or more social networking services hosted by another of the server(s) 6, through a client application software installed at the electronic devices such as mobile devices 3, computers 4, and other devices 5. Alternatively, the user may interact with the system and the one or more social networking services through a web based browser application at the electronic devices such as the mobile devices 3, computers 4, or other devices 6. Communication between client devices such as mobile devices 3, computers 4, or other devices 5 and the network system 1, and/or one or more social networking services, may be facilitated through a network 2 as explained above.

The network 2 can include, for example, any one or more of a personal area network (PAN), a local area network (LAN), a campus area network (CAN), a metropolitan area network (MAN), a wide area network (WAN), a broadband network (BBN), the Internet, and the like. Further, the network 2 can include, but is not limited to, any one or more of the following network topologies, including a bus network, a star network, a ring network, a mesh network, a star-bus network, tree or hierarchical network, and the like.

A user which is using one of the electronic devices (3, 4, 5) may access a software application present at one of the electronic devices (3, 4, 5) and/or through a link between the electronic devices (3, 4, 5) and a server 6. Most preferably, the software application which interacts with the user is present in the electronic devices (3, 4, 5) and the information provided by the user is then stored on a secure remote server 6.

Many of the features and applications of the present invention are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, or storage in electronic devices (such as “flash drives”) which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

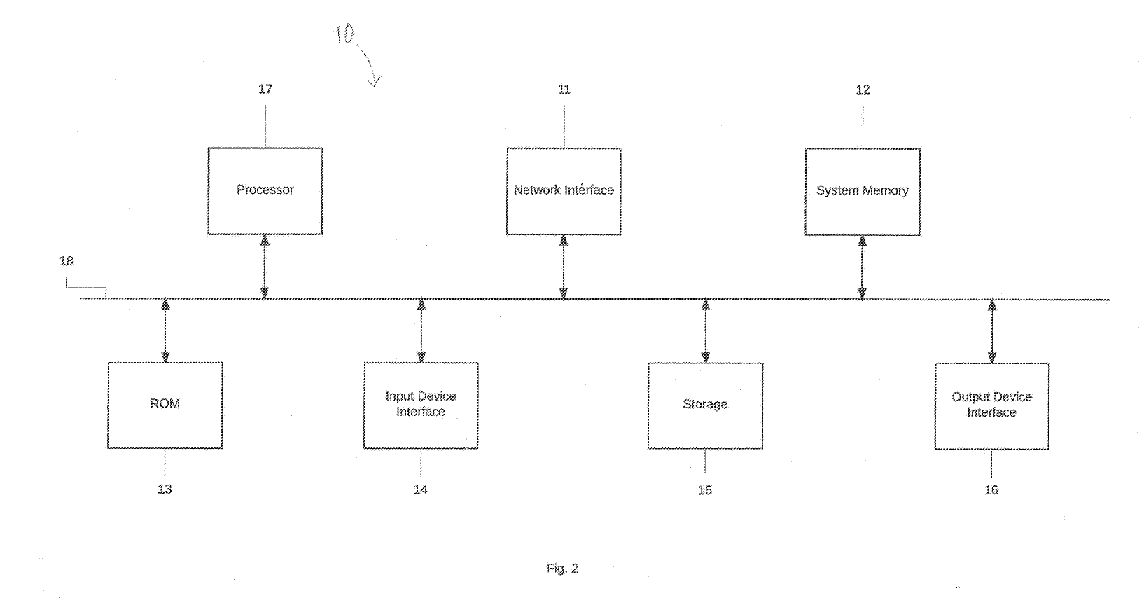

FIG. 2 shows an electronic system 10 which can implement the subject technology. Electronic system 10 can be a server, computer, phone, PDA, laptop, tablet computer, television, image capture devices (e.g., cameras, glasses, etc.), with one or more processors embedded therein or coupled thereto, or any other sort of electronic device, or a combination of devices. Such an electronic system includes various types of computer readable media and interfaces for various other types of computer readable media. Electronic system 10 includes a bus 18, processing unit(s) 17 (referred to as “Processor” in FIG. 2), a system memory 12, a read-only memory (ROM) 13, a permanent storage device 15 (referred to as “Storage” in FIG. 2), an input device interface 14, an output device interface 16, and a network interface 11. The electronic system 10 does not necessarily require each element.

Bus 18 collectively represents all system, peripheral, and chipset buses that communicatively connect the numerous internal devices of electronic system 10. For instance, bus 18 communicatively connects processing unit(s) 17 with ROM 13, system memory 12, and permanent storage device 15.

From these various memory units, processing unit(s) 17 retrieves instructions to execute and data to process in order to execute the processes of the subject disclosure. The processing unit(s) 17 can be a single processor or a multi-core processor in different implementations.

ROM 13 stores static data and instructions that are needed by processing unit(s) 17 and other modules of the electronic system. Permanent storage device 15, on the other hand, is a read-and-write memory device. This device is a non-volatile memory unit that stores instructions and data even when the electronic system 10 is off. Some implementations of the subject disclosure use a mass-storage device (such as a magnetic or optical disk and its corresponding disk drive) as permanent storage device 15.

Other implementations use a removable storage device (such as a floppy disk, flash drive, and its corresponding disk drive) as permanent storage device 15. Like permanent storage device 15, system memory 12 is a read-and-write memory device. However, unlike storage device 15, system memory 12 is a volatile read-and-write memory, such a random access memory (RAM). System memory 12 stores some of the instructions and data that the processor needs at runtime. In some implementations, the processes of the subject disclosure are stored in system memory 12, permanent storage device 15, and/or ROM 13. For example, the various memory units include instructions for generating and maintaining a catalogue of belongings for a user according to various implementations. From these various memory units, processing unit(s) 17 retrieve instructions to execute and data to process in order to execute the processes of some implementations.

Bus 18 also connects to input and output device interfaces 14 and 16. Input device interface 14 enables the user to communicate information and select commands for the electronic system. Input devices used with input device interface 14 include, for example, alphanumeric keyboards and pointing devices (also called “cursor control devices”), as well as image capturing devices such as cameras and video recorders, and audio recording, storage, and processing equipment. Output device interfaces 16 enables, for example, the display of images generated by the electronic system 10. Output devices used with output device interface 16 include, for example, printers and display devices, such as cathode ray tubes (CRT) or liquid crystal displays (LCD). Some implementations include devices such as a touchscreen that functions as both input and output devices.

As shown in FIG. 2, bus 18 also may couple electronic system 10 to a network (not shown) through a network interface 11. In this manner, the electronic system 10 (such as a computer) can be a part of a network of other electronic devices, such as computers. The network can be a local area network (“LAN”), a wide area network (“WAN”), or an intranet, or a network of networks, such as the Internet. Any or all components of electronic system 10 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

Some implementations can be performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer (whether a desktop, laptop, or mobile phone) having a display device, e.g., a CRT (cathode ray tube) or LCD (liquid crystal display) monitor, for displaying information to the user and a keyboard and a pointing device, e.g., a mouse or a trackball, by which the user can provide input to the computer or other input devices such as buttons or knobs. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, visual, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In an aspect of the present invention, an inventory management method or system which is web enabled as well as enabled for mobile use is utilized for identifying home and business structural features and creating an inventory of all assets via photos and/or videos and/or descriptive text and other documentation. This inventory can be used to submit insurance claims, for estate sales, for appraisals, to get insurance, etc. The software will present specific fields for the value of the item, and the description and location of the items within a building. The storage of the information will be on the “cloud” for safety record-keeping purposes. In the present specification, the term “location” means a portion of a building in which the items to be inventoried are present or are to be associated with such as a kitchen, garage, etc. The term “room” will be used interchangeably with the term “location”. The term “items” are the objects to be inventoried and can also be referred to as “assets”. In the present description, the term “building” shall be utilized to designate a house, a factory, an office, a unit in a multi-unit residence, etc. The term building is used generally to designate a structure with walls and a roof.

Currently, many homes and businesses are not insured to the value that is actually present in the buildings at issue since no inventory of belongings has been created. The software which is the subject of the present invention facilitates the creation and maintenance of the inventory, as more fully described below.

The present invention is directed to a method and system for managing inventory, and has various steps and features in the method and system, as described below. The method is directed to the steps of managing the inventory. The system is the equipment and software which facilitates the execution of the method. The types of equipment which can carry out the method is explained above, such as in FIG. 2, and other parts above. For example, a microprocessor in a mobile device will interact with other components to “run” the software of the present invention.

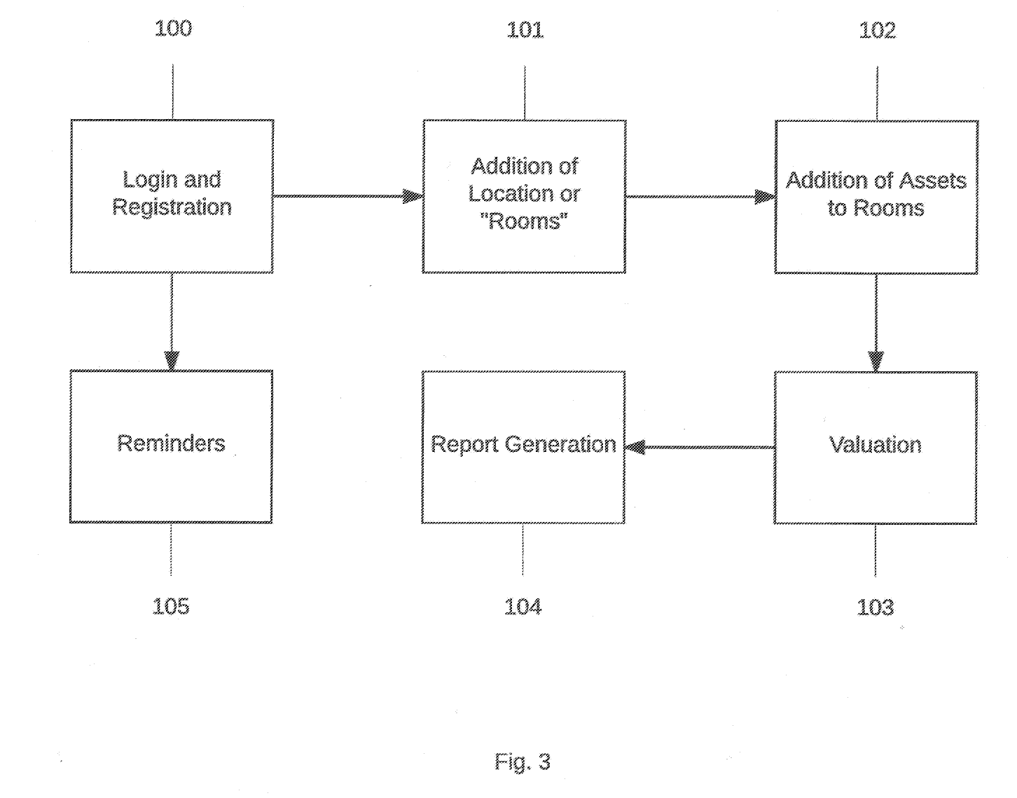

FIG. 3 shows the main steps of the method of the present invention, as more fully described below.

Login and Registration

As shown in FIG. 3, one step in the system of the present invention is the login and registration step 100. In the login and registration step 100 of the present invention, a user visits a website via a computer or mobile device and if the user is a current user and can enter valid credentials, such as user name and password, the user can then take advantage of other steps. If the user is not a current user, the user can register for the service where credit card information can be provided for payment. The user can input initial data, which includes name, address of property (or more than one if there will be an inventory of multiple buildings), phone number, email, payment mechanism. The user can be prompted by the software application the number of bedrooms and bathrooms on the property. The user can also be directed to the payment screen for choosing among different payment options. All of the information provided by the user is preferably saved on a secure remote server, although some of the information can be saved locally on the mobile device or computer used to access the website.

In an aspect of the invention, all credit card information is stored with a third party firm to provide even additional security to users. Thus, accessing (or hacking) the information of a user online on the remote server where the information inputted by the user (such as the information on the property, locations, and assets) is stored would not result in the user's credit card information being compromised as this would be stored on a different location, which is a different remote server of a third party. If the user is a current user and the login credentials match, or if the user registers, the user can add a first property to the system (or new properties if it's a current user). One of the pieces of information which may be requested when inputting an address of a property is an outside photo of the entire building. This way, when the user goes into the system, the user can look at the photos of various properties (when using the multi property feature within one account) and pick the right one. The user can also customize the property name to what is readily recognizable. For example, if the property is a home on the beach, the user can call it “beach house”. The presence of a photo or photos of the “beach house” would make it readily identifiable to the user when looking at the list of properties that this is the “beach house” since owners know their properties by sight more than by name. The software application may prompt the user to either upload saved photos of the exterior of the property or to take the pictures with the device of a user, such as a mobile phone, which is being used to access the software application via the Internet. The photos are then processed and the software application preferably saves the photos on the remote secure server.

The software application also may prompt to obtain the name of the insurance agency and a copy of the insurance policy in connection with the property being inventoried. The insurance policy may be downloaded if a copy exists already or a photo can be taken with the device used by the user to access the software application. The photo or existing file would then be preferably saved on a remote server and associated with the particular property being inventoried.

As more fully explained below, it is possible for users to give access to information on the software application to third parties. When someone (whether it is a user or a third party) accesses the site, the software may prompt this accessor to identify whether this accessor is a homeowner, renter, or insurance agent, or adjuster, or estate attorney, or appraisal firm, etc. A “user” is an entity which is using the application software to manage an inventory. A “third party” is an entity which is using the application software to look at the inventory of a “user”. Any entity which accesses the site will have to register upon the first use and then login upon subsequent visits.

Addition of Locations or “Rooms”

As shown in FIG. 3, another step in the system of the present invention is the step of Addition of Locations or “Rooms” 101. In this step of the invention, the user may be prompted to identify “locations” or “rooms” (or “category” such as jewelry or electronics) inside and outside of a building. In the present application, the term “locations” and “rooms” will be used interchangeably and will represent general spaces in a building that can hold inventory, such as a living room or a garage or an office, or a suitcase, or anything else that the user desires, as more fully explained below. The software of the present invention can present the user with standard names for locations such as master bedroom and the user can choose the standard name from a list. The list can also include names which have been previously written in by the user for any property in the system. Alternatively, and preferably, the software will permit the user to name locations at the discretion of the user so that they are customizable to the user and more descriptive in the mind of the user. For example, the user can identify locations such as “John's room” (e.g., to identify a room inhabited by John) or Library (e.g., to identify a room with many books). The location or “room” can also be an object which can store other items, such as closet, file cabinet, and safe, which are storage items, and these are customizable too and can have customizable names such as John's cabinet (to identify a cabinet mainly used by John), or Abby's safe (to describe a safe with Abby's belongings). The name of a category such as House Jewelry can also be added as a “location” or “room” of the property, to facilitate the user in creating the desired inventory of a particular category. In essence, anything can be considered a “location” or “room” in the context of the software application in order to facilitate flexibility on the part of the user in deciding what is to be inventoried and how it will be categorized.

When creating a “location” or “room”, a user may be asked for a description so that at a later time it is readily apparent what was meant by the user. The user can also take pictures and/or video (or upload them) of a “location” or “room” to make it more identifiable as to which location it is, in addition to or in lieu of providing a description. For example, John's room can be described as the bedroom where John sleeps on the second floor of the house. Photos and/or video of the room can be included to more fully differentiate this room from other rooms in the property. All of the information obtained from a user will preferably be saved in a secure remote server. It is possible, though, to save the information on a local server or hard drive or on the device itself which is used to access the software. A remote server is preferred due to security and safety issues since a local drive can be lost, stolen, damaged, or corrupted. A location can have any name, even “miscellaneous” for items which do not have a permanent place in the house or just for convenience of the user.

Addition of Assets to Rooms

As shown in FIG. 3, another step of the present method and system is the Addition of Assets to Rooms 102. The user can choose a room for which to add assets. Assets can also be referred to as “items” in this description. The user will then upload photos and/or videos previously taken of the asset, or take the photos and/or videos of the asset in real time with an image capture device, preferably the device that the user is utilizing to access the software of the present invention for convenience. In this step, photos and/or videos are taken and added to a master list, or to specific master lists, or to particular locations, or to sub-files at particular locations. Preferably, the photos and/or videos are added and associated on a location-by-location basis. The photos and/or videos are of the items and/or structures which are in a location and which are to be included in the inventory list to be managed by the software. The photos and/or videos are dated internally when added to the application software so that it is clear at which point in time the photographed items and structures existed, which will give additional credibility to insurance claims in the event of loss or damage since the dates will prove the existence of the items and structures at issue at a certain point in time. If an item is moved to a different location or property, the software can be requested to move the item to a different location or property. The initial date when the photo or video was first added in the software is maintained and the date of moving of the photo or video to a different location will also be saved so now there is proof of when the item existed in the first place and when it was moved from one location to another and also when it is removed and replaced. This will avoid the need to retake photos and/or videos, or re-enter information, and will avoid losing the time-stamping that existed for the initial entry of the asset into the system. If a particular location has damage, such as fire, photos and/or videos can be taken of the location after the fire so that the user has the “before” and “after” photos and/or videos and can share this information with an adjustor, agent, insurance company, etc. so it is easier to document and prove a loss.

All of the photos, videos, or even the addition of an asset without any photos or videos can be time-stamped and the time and date of initial entry will be saved for future reference. Any moves or modifications will also be time-stamped, and the original time-stamping can be saved for future reference so there may be a time-stamping for initial entry and another for moving the item from one location to another or replacement. If the “location” is a “safe”, then items that are in the “safe” can be listed as assets and the list will be associated with the safe. Even important documents that may not be needed for insurance purposes can be documented such as passports, birth certificates, stock certificates, wills, trusts, etc., and they will all be time-stamped to prove authenticity. If the safe has jewelry, photos can be taken and will also be saved for future reference and included in the inventory.

A photo and/or video is transferred to the software application, whether by uploading if previously created, or by creating the photo and/or video through the software application in combination with the device used by the user to access the software application. Once this happens, the user may be prompted for a description, approximate values and tag words for the particular asset associated with the photo and/or video so an asset can easily be found using the internal search engine and for proper identification purposes in addition to the photograph and/or video. The search functionality can also help organize assets into categories, as well as finding the location or room for the item. Additional photos and/or videos can be added in connection with any asset to include warranties, receipts etc. As rooms are partially or totally completed, new rooms can be added at any time. It is noted that a photograph or video is preferable, but not necessary, to enter an asset into the software. It is possible to skip the photo and/or video entry step and simply put in a description, approximate value and tag words for a particular asset. At the top of every photo and/or video, there may be identifiers showing the room it is in, the date it was added, and/or approximate value, for easy viewing.

As stated above, preferably, assets are added and associated on a location by location basis. Thus, the choosing of assets is preferably done for each location. However, lists of assets can be created separately and not in connection with any particular location, and added to a particular location afterwards. For example, photos and/or videos of furniture in the master bedroom can be added to the location of “master bedroom” to associate photos and/or videos of the furniture in the master bedroom to the master bedroom. Alternatively, photos and/or videos can be added to a “category” location called “furniture photos and videos” which can be created without any designation of a real location and can be included generally as something which is in the building. Subsequently, the items which are to be associated with the master bedroom can be moved to the master bedroom or simply copied to the master bedroom so that the “category” location can still exist. The reason for doing this is that the user may want to take photos and/or videos of all of the furniture in the building and create one “category” location with all of those photos. The user could then take some of those photos and/or videos and associate them with a particular location such as master bedroom or a different “real” location. Thus, the software is customizable in that there can be two locations for furniture photos and/or videos, one being the master bedroom and one being a placeholder which has photos and/or video for all of the furniture of the building. This can be done for any list or collection of assets. Moreover, the database can be searchable so that a comparison can be made between the contents of a “category” location which includes all of the furniture assets, for example, and the contents of individual locations, and identify any discrepancies.

For example, if someone takes photos and/or videos and documents of all of the furniture of the building and provides information for all of those assets, then photos and/or videos can selectively be associated into locations where they belong. If a new furniture asset, with or without photo and/or video is added to the main list, a comparison with all of the locations will identify a missing asset with or without photo and/or video if the new furniture asset has not been added to a location. Analogously, if a furniture asset is removed from either a particular location or the master list, a comparison would result in an indication to the user that there is a discrepancy. The ability to make generic lists is important for people who want to catalogue their belongings before a move and who do not need to specify a location for each asset since they have not moved to the new location yet. In fact, this is very convenient since the identification of the items to be moved can be used to get a pricing on the move, and to keep track of what is moved in case there is any damage or missing item. It is also convenient to be able to put in all of the assets before a move into a main list and then associate each asset to a particular room in the new location once the move is complete. The step 102 is called “Addition of Assets to Rooms” since, preferably, assets are added in connection with particular rooms. As stated above, assets can be added without connection to any room.

The application software can also include photos of warranties and appraisals in connection with each asset. The photos and videos of the present invention can also be tracked by location. The software can have a GPS location functionality that tracks where the photo or video was taken and is saved in order to confirm that the item was in the appropriate location for proof of loss. Thus, the device used by the user can have a global positioning system configured to provide a geolocation tag for the image data and the software will obtain this information from the device (such as a smartphone) which is used by the user to access the inventory management software. Geographic information embedded in the captured image or otherwise accessible through the image capturing device (e.g., by querying a location service) is retrieved to verify the location of the images being captured. In one example, the user's belongings are associated with the user dwelling and the list is generated for insurance purposes. In such examples, the verification of the geographic location of the images as being within the user dwelling allows for a list of user assets within a building, for example, for future use in case of damage and/or loss. In some embodiments, the software does not have a GPS functionality and/or does not keep track of the location of where the photo or video was taken.

As mentioned above, it is also possible to add assets without photos or videos. For example, if someone has jewelry, this can be documented by a list and, if available, other documentary evidence such as appraisals, receipts, etc. It is up to the user how the assets will be described, and whether it is with a video and/or photo and/or description.

It should be understood that when an asset is “added” to a room, this means that the asset is associated with the room. Some of the assets that can be added to a room are the structures in a particular location, such as baseboards, windows, framing, walls, columns, carpet, flooring, siding, roofing, and the overall condition of the property. Structural photos can show before and after photos to determine loss. Homeowners will also want to take pictures of the structures since that is a good way to show the structure, although a description can technically be sufficient without a photo. A photo or video would be good to demonstrate the condition of the structure. While this is not necessary for a renter as their coverage is for contents only, it is a good practice to know the condition of a home. The structures will be treated like any asset in that photos and/or videos and/or descriptions can be utilized.

As stated above, the approximate value of assets may be requested by the software application. To the extent that such information is provided, a “value” field for each location will tabulate total approximate value of the assets for any given location as well as for selected lists created by the user.

As stated above, the software may also ask (i.e., prompt) for tagwords for each item/asset. The user can decide which tagwords to use, including the name of the item and other descriptors. When the user requests a search, the software conducts it and the searched terms may automatically include the name of the item as well as the tagwords.

A user may want to take multiple photos or videos of the same item and additional photos and/or videos can be added in association with an existing asset which is already documented in the software. When a user accesses a particular location, the software can display only the first of a plurality of photos and/or videos or all of them or none of them, as set up by the user in the software. For example, this is useful in a situation where a user wants to see photos and/or videos for a particular asset on the screen and if an item has 5 photos taken of it, the first one may be shown on the screen and the other 4 can be saved and be accessible but not shown automatically to save space on the screen unless requested by the user. The user can also opt not to have any photos shown and to show only the description of the asset. The user can decide whether they want the description and/or photos and/or videos and/or one photo or video and/or multiple photos or videos displayed on a screen. Photo files or scanned files or other image files can also be created to include warranties, receipts, and insurance policies relevant to the items in the room. Even better, if the receipts, warranties, and relevant insurance policies are uploaded in connection with a single item, such as an antique bed for example, the system will maintain this information together so that a user can open the file for the antique bed and have the receipts, warranties, and insurance policies accessible and printable. The receipts, warranties, and insurance policies can be uploaded if they have been previously downloaded, or photos and/or videos can be taken in real time and the photos and/or videos would be associated with the items related to them. It is possible to use the software to upload an insurance policy (or take a photo of one), with information on the insurance and contact information, and the user can then open the document to review it in the event of loss since the information is safely stored on the cloud.

In one aspect of the invention, when photos and/or videos are taken, the photos and/or videos are merely processed to show the images of the items which were photographed and/or videotaped. There would be no functionality in the software to automatically identify the item or discern any information about the item which was photographed and/or videotaped. In this case, the identifying information on the photo and/or video would be inputted into the software by the user.

The software can compare the addition of any new asset with other existing assets to determine if it may be the same asset. If it determines that it may be the same asset, the software can inform the user. For example, if the user identifies more than one asset with the exact name and/or value and/or a similar name and/or value, the software can identify this to the user so the user can check if the same asset was included more than once by mistake. For example, if two items have two or more tagwords in common and the same value, the software may inform the user of potential duplication.

Valuation

As shown in FIG. 3, another step of the process and system of the present invention is the Valuation step 103. Once values are inputted for assets in one or more locations, the inventory system can add up the values on a particular room and/or for the entire building so the user understands the value of what is contained in the building in order to secure insurance or file a claim to an insurance company in the event of loss. One aspect of the Valuation step 103 is for the user to ask for a calculation of value, where a user identifies which items or rooms or the entire house will be utilized to calculate the value of the items. For example, if a bed is damaged, the calculation can be limited to the bed. If five assets are damaged or lost, the calculation can be limited to those five items. If a whole room is destroyed, the valuation can include all of the assets of the room. If the building is totally destroyed or a user wants to know the value of all items to determine how much insurance to obtain, the valuation can be for all of the assets of the building. The user decides what properties, locations, and assets are included in the valuation and the software will perform the calculation. The calculation can be used on particular categories such as jewelry, since sometimes people have a separate policy or rider for these types of items. The calculation can be used on one or more locations in a building such as the garage and basement, and can be used on the entire house. The resulting calculations can be used to determine whether current insurance is adequate and can be used to submit claims to an insurance company. While the calculations do not necessarily have to be accepted by an insurance company when starting a policy or when a claim is made against a policy, they can be very useful nonetheless. The calculations provide significant guidance for what the items are worth and can be very helpful when planning to obtain coverage and when submitting a claim, and even if there is a dispute with an insurance company after a claim has been submitted. Moreover, the documentation which is enable by the present invention will likely improve the speed and accuracy of claim processing by insurance companies since much of the information requested by the insurance company would be present, organized, documented, and accessible to the insurance company.

Report Generation

As shown in FIG. 3, another step of the method and system of the present invention is that of Report Generation 104. As part of this step, a report can be generated with values for individual items, collections of items, items in certain locations, or even the entire building, as requested by the user. The values can be itemized and/or identified collectively, as requested by the user. The values as calculated will be displayed by the software on the device used by the user, such as computer or mobile device. In the event of an insurable loss, or if an estate needs information on certain items, or new insurance is being obtained, or the items are otherwise needed for a purpose, the user can select the information they want to be included on the list on a case-by-case basis. The information can be of some of the items in one location, or all of the items in a location, or some of the locations in the building, or all of the locations in the building, or the information can be of a particular category such as jewelry, or furniture, etc. The information can include just data or it can include some or all of appraisals, photos, videos, receipts, warranties, insurance policies, appraisals, and other documents, as selected by the user. The list will have a name and date associated with its creation and this will be archived. Then, the user can send a link to someone or an organization (otherwise referred to as “third party” or “third party user”) to access the list and/or its contents, and/or the user can send someone the list directly via email rather than a link to access the list on the cloud. The link to the information and/or the actual information can be sent by the software via email or other electronic communications, such as downloading into a designated area for the third party or to a social media account (presumably if confidential). Additionally, the software can allow downloading of the information by the user and the user can send the information and/or link directly to the third party. It is preferred that the software send the information and/or link to the third party to document this, so the user would provide contact information for the third party, such as an email address. The software application can prompt the user for this information. The software can also document which third party accesses the information remotely for redundancy in documenting access to the information. The software will keep track of who got the information or accessed the information and when and can generate reports or send them to the third parties. The reports can include information on previous steps of getting the information to the third party. The software can prompt the user for the email of the recipient and as selected by the user, send a link to allow access to the information or an email with information, or otherwise provide the information electronically, or a combination. The email will preferably be sent by the software from an email address of the software (not of the user) in order to improve credibility in the event of a dispute with an insurance company. At the request of the user, the software can send an email from the user's account instead.

The user can select a list of items and value to be emailed to an insurance company and also provide the insurance company with a link to the list on a remote server so that the insurance company can access photos and/or videos through the link to the remote server rather than getting a huge email with many photos and/or videos. The software can also, as requested by the user or automatically, compress files or turn them into zip files to reduce the space on the email. Potential recipients are insurance companies in the event of a claim or if new insurance is being sought, or estate auctioneers who want to know what can be sold. This can be useful for estate sales to inform people of what is available. This can even be used for garage sales. Other potential recipients can be third parties which obtain one of the items if, for example, the item is given away or donated. This information can also be sent to accountants or lawyers in the event of a sale or donation for proper documentation purposes.

If the third party has the same software, the information can be uploaded into their system for convenience. Thus, if a property is sold, a large inventory such as washers, dryers, and structures can be provided to the buyer and if the buyer is registered for the software application, the buyer can upload the information to a list or into the actual locations where the objects are located, and this is also time-stamped for future reference and the initial time-stamp of the original owner is also maintained for reference. This is convenient since the buyer of the property would already have many of the assets already in the software and reduce the amount of time needed to have a complete inventory. The information can be sent to movers to get a moving estimate or if there is a loss can be used to prove to a mover the extent of the loss. People who move can use the list to make sure nothing is missing and also to remember where certain items went before and where they should go in the new dwelling since sometimes people like to have consistency in this respect. Also, since the information is already in the system, moving does not require re-entry of everything, just merely re-categorizing the location of the items on the list. This system is therefore particularly convenient for people who move a lot such as those in the military or executives for large companies who change jobs frequently. The information can be useful for donations since it has a description of what was donated and approximate value so it's easy to document what was donated and when and when it was acquired and would be useful to properly account for deductions in income tax returns.

The information which is sent to a third party or to which a third party is given access to will be time-stamped so there is a record of what information was sent to whom and when and/or when a third party was given access to information and what that information is. Thus, there will be a record of what a list contains and when the list was emailed to a third party and/or a link was sent to the third party with access to the list, as well as a record of who the third party is. This will speed up insurance claims, especially in catastrophic losses since people need to submit claims quickly and accurately, and in the event of delay on the part of the insurance company, there is a documented record of what was sent to the insurance company (or give access to) and when. This will also help with accuracy of payouts due to the simple, effective, and documented system of managing the inventory and sending the information to the insurance company. If an event creates loss, such as a fire, the list that is created can be a list of losses, as opposed to what was in the location before the adverse event. For example, a list can be “fire in basement”, and it contains the list of items which were lost during the fire. The insurance company can receive and/or be given access to the initial list of what was in the basement as well as the list of items which were lost, in order for the process to be more transparent and for the insurance company to have more faith and better information to process the claim. The two lists (a “before” and “after” list) can be sent by the software to the insurance company and/or a link to the lists on the remote server, so that the insurance company can quickly determine what was there initially and what was damaged. The software can also be used to send and/or provide access to a list with assets which are paired in terms of before and after condition so a description and value of an asset can be associated with both the before and after photo in the event of damage. A list can be generated for the insurance company where it is easy to see the before and after photos of each asset for easy identification by the insurance company on an asset by asset basis.

If a link or login information is provided to a third party, or the third party is otherwise given access to a user's information, the user can allow the third party to see descriptions, photos, and/or to have the software generate a list organized as requested by the third party. Preferably, the user will decide which properties and/or locations and/or assets the third party will have access to and send the third party a link, or login information, or other information to allow the third party to access the property and/or locations and/or assets that the user wants the third party to be able to see. Once the third party accesses the information via the software application, the third party will, essentially, be able to see the same information as the user for the items that the user has given access to the third party. For example, if an insurance company or other third party is given access to a list of ten assets, the insurance company or other third party will see the photos and videos and descriptions and tagwords, and locations for those ten assets and would be able to use the software application to calculate the value of the ten assets or a subset thereof, on a category basis or on a location basis, or the insurance company could arbitrarily select certain assets to calculate a valuation by adding up the values that had been inputted by the user. Thus, if the information is not listed conveniently for the insurance company (or other third party), the insurance company or other third party, if given permission by the user, can re-arrange the way the information is displayed to see it in the way the insurance company wants it. For example, the insurance company or other third party can organize the list by category, by before and after, or can create two lists (one with all the items and one with the damaged items), or can choose item-by-item listing, listing by valuation, listing by location, or listing as otherwise arranged by the insurance company or other third party. The insurance company or other third party can also create different valuations by room or by structural damage or by property as they wish. Thus, providing a third party access to the information can allow the third party to manipulate the way the information is displayed to be of maximum use to the third party. This can improve the convenience for the insurance company and other third parties and speed up claim processing. The sharing with a third party can be by room, by item, by part of room, by category, or by whole house, as selected by the user, and preferably, the third party can manipulate the display of information as desired by the third party. While the third party cannot change the information in the system, the third party can see and manipulate the information that it does have access to for the creation of various lists with various calculations for valuations.

The software application will also allow the third party to download and/or print the information being accessed. The third party can also have an excel spreadsheet generated by the application software that includes some or all of the information of the assets for which access has been given, including the names, descriptions, and valuations of those assets, as arranged by the third party in a customizable manner. As stated above, all of the sending of information or of access to information will be documented so it's clear what was sent/shared and with whom and when and for what purpose. The ability to send the list (or provide access to the list) is very useful, especially the time tracking and the ability to include other documents on the list. For example, a user can submit a claim to an insurance company, and upload the claim into the application software and the claim would be included in the documents which the insurance company receives and/or can access via a link to the application software so the insurance company can quickly cross-reference the claim information with the supplemental information provided by the application software. Other recipients could even include builders and others who may want to provide quotes to fix damage in a building and the pictures which are shared may have the “before” and “after” information for proper bidding by potential builders or restorers.

One convenient scenario would be to send a list to a builder (or to provide remote access to the list by the builder) in order to get a bid on the work. Then, the list as well as the bid can be sent to the insurance company for convenient and expedited processing.

The Report Generation step 104 an also re-generate a report. For example, if a list is sent to a third party and/or shared with a third party, this will be documented. If the user wishes to re-send and/or re-share the list a second time, this can be done and the user can choose for the list to include information about the first sending and/or sharing. For example, if a user submits a claim to an insurance company, and then makes the list accessible to the insurance company (via link or email, for example), and a few weeks later the claim is not being processed promptly, the user can make the list accessible to the insurance company a second time. The link or list would be sent to the insurance company and would include the information from the prior access that the insurance company was provided so that the insurance company is on notice about what was done and of any delay in processing. Also, the user can be notified when a third party accesses the information on the remote server, and document this. A user can also be notified if a third party does not access the information on the remote server after a certain predetermined time (as selected by the user) from when access was provided by the third party. The user can also be notified whether or not an email sent to a third party was opened or not.

When a list is accessible to a third party via link and/or email or otherwise, the user can elect to share the dates the assets were inputted into the system so that the third party knows at which point in time the assets were present in the building at issue.

Reminders

As shown in FIG. 3, one of the steps in the method and system is that of Reminders. Once a user is registered, they may be reminded via email or text or other electronic communications such as social media to make updates when a significant weather event appears likely to occur so they can input their information into the system in advance of potential losses. Additionally, users may receive an email or other electronic communication on a regular basis (such as monthly), reminding them to continue to update their new acquisitions or structural changes.

In FIG. 3, six main steps are shown for the method and system of the present invention. Not all of the steps are needed every time the method or system is utilized, and not all of the steps are needed in their entireties when they are utilized. For example, once a user is registered, there is no need for re-registration in the Login and Registration step. Furthermore, once a property is entered into the system, there is no need to add additional properties in the Login and Registration step (if not more are desired by the user). Once there is at least one location added in the Addition of Locations or “Rooms” step, in a subsequent use of the software, a user can merely go to the addition of Assets to Rooms step. Similarly, once there is at least one Asset added into the software, in a subsequent use the user can use the software to input or modify information and/or photos and/or videos for that asset, or can conduct the Valuation step 103 or the Report Generation step 104. In other words, the arrows shown in FIG. 3 show one possible embodiment of the present invention. However, other embodiments which include executing different steps at different times or partial steps at different times or only some of the steps some of the time is envisioned by the present invention. In fact, a user can sometimes merely go into the software to look at what is in there by clicking on different locations and assets and without necessarily asking for the Valuation step 103, Report Generation 104, or adding any asset or locations to the system.

In some instances, a particular third party user, such as a public adjuster or an insurance agent, may have more than one user provide them access to information on the application software. In this case, once the third party user becomes a registered user of the application software (see Login and Registration step 100 in FIG. 3), and is given access by more than one user, the third party user can log into the system and be able to see all of the users that have given that third party user access. The third party user can then select from among the list of users which one's information the third party user wants to look into and could select a particular user and would then have access to the information of that particular user. This is very convenient and efficient for the third party user since creating a separate login and/or having to log in separately for each user would be burdensome and inefficient. For example, if an insurance agent has one customer who uses the application software to provide access to information to the insurance agent, the insurance agent can register (if not already registered) to use the application software. Once the insurance agent is a registered user of the application software, the insurance agent would then be able to access the information of the one customer on the application software. If subsequent to that 19 more customers of the insurance agent give the insurance agent access to the application software such as by sending a link to the insurance agent or putting the insurance agent's email address in the application software to allow the insurance agent access, or otherwise giving the insurance agent access, then the insurance agent would have twenty accounts it could access on the application software. If the insurance agent were to log into the application software, the insurance agent would see a list of twenty users whose information could be accessed by the insurance agent without any additional logins and the insurance agent could merely select a user and would have access to the information that the particular user has allowed that insurance agent access to. If the insurance agent then wants to see the information for user #5, the insurance agent can merely select such user. If the insurance agent wants to see the information for user #15, the insurance agent can merely select such user.

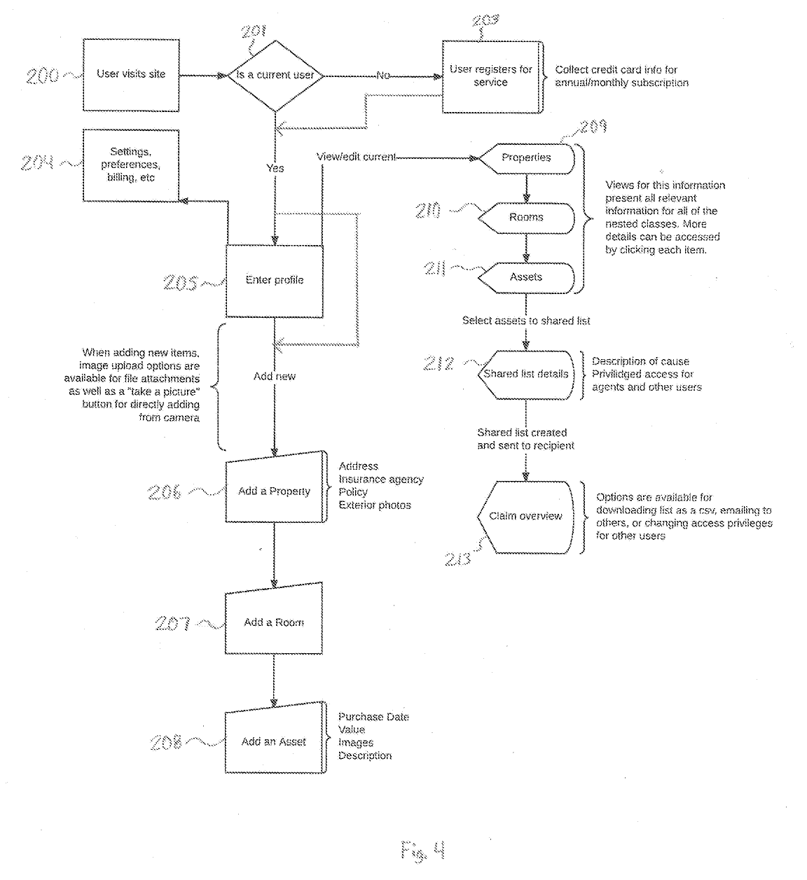

In FIG. 4, the method and system of the present invention is shown in a different layout where the two main aspects of the method and system are shown in two interconnected diagrams. On the left side are the steps to enter information into the system and on the right are the steps to review information. These steps will be explained in more detail below.

A step of the method and system is the user visiting the website (of the application software) step 200. In terms of the website, this can be enabled for standard internet access from a computer or it can be enabled for mobile viewing on a mobile phone, or on a tablet which is connected to the internet. The software can be downloaded onto a computer or mobile device, or the software can be accessed via an internet browser. A combination is also possible where some aspects of the software are downloadable to a computer or mobile device which then connects the user to a remote server which contains the remainder of the software. The system of the present invention preferably requires access to the Internet since some or preferably all of the information of the user is stored on remote servers, or the “cloud” for safety. Once the user conducts the visiting of the site step 200, the software checks via a login whether or not the user is a current user. The login can be with a username or password, or with a pre-saved digital fingerprint, or in some cases, by identification of the device used to access the website. This step is identified as step 201 in FIG. 4. If the user is not a current user, then the software prompts the user to register for service. The user registration for service step is identified by number 203 at FIG. 4. The registration for service is explained in more detail in the step of Login and Registration in connection with FIG. 3 as explained above. Such information will not be reiterated here for the sake of brevity.

Once a user registers, then they are considered a current user. If the user is a current user, and they do not have a profile, they will be requested to add a profile via the enter profile step 205. This is part of the Login and Registration step in FIG. 3 where the user inputs information about themselves and will not be reiterated here for the sake of brevity. Once there is a profile in the system, the user can access the software at a later time and change the profile, or immediately go to other steps without having to input any new information into the profile.

Once the profile is in place, the user can execute the Add a Property step 206. This is described as part of the Login and Registration step 100 in FIG. 3 and will not be reiterated here for brevity. Then, the user can execute the Add a Room step 207. This is described in the Addition of Locations or “Rooms” step 101 in FIG. 3, and is not reiterated here for brevity. Once a room is added per step 207, then the user can engage in the step of Add an Asset 208. This step of adding an asset 208 is described in the Addition of Assets to Rooms 102 in FIG. 3 and is not reiterated here for the sake of brevity.

Once properties are included in the system, the user can review the information in the system for a particular property via the Property step 209. Once rooms are included in the system, the user can go into rooms and look at particulars of the rooms via the Rooms step 210. Once assets are included in the system, the user can review the information for each asset via the Assets step 211.

In the event that the user wants to create a list for sharing, the user can create a shared list via the step of Shared list details 212, where the user will decide how a list of assets will be shared with other people (e.g., via an emailed list or a link to enable access to the application software), and identify the assets to be shared. This is described in the Report Generation step 104 of FIG. 3 and is not reiterated here for brevity. The arrow pointing between step 212 and step 213 states “Shared list created and sent to recipient”. As explained in the Report Generation step 104 of FIG. 3, this can involve giving a third party access to information on the website of the application software, or sending them an email with information, or a combination of both. The information does not necessarily have to be sent via email, as other methods of communication are available such as downloading the files on a hard drive or other storage device under the control of the third party. For example, an insurance company may have a service or procedure where policy holders can download information for the use of the insurance company to process claims, and the present invention can download the files where requested by the user, provided that the software has the credentials necessary to access such storage device.

As stated in the Report Generation step 104 of FIG. 3, a third party user who is given access can see and manipulate the way information is presented on the application software for the assets it is given access to by the user. This is not reiterated here in detail in the interests of brevity.

Another step in FIG. 4 is the Claim overview step 213, where the user can download shared lists, emailing it to other people (including the user), or changing access privileges for others who have access to lists. The user can re-send the information, such as to an insurance company. More details are found above with respect to the Report Generation step 104 and are not reiterated here for brevity.

As mentioned above, the present invention is directed to system and method for managing an inventory and this requires the user of the software of the present invention to input information into the software, whether it be during the addition of properties, locations, or assets, or the addition of other documentation. In an embodiment, the software will send to the device associated with the user a request to enter information and/or to capture image data and/or upload image information. The request can be for information with respect to the property being inventoried to be typed in or spoken into a microphone, or it can be a request to capture image data that includes at least one image of the building being inventoried, or the request can be do upload a file with an image of the building being inventoried or of a document associated with the building. Preferably, the software will send to a device associated with a user a request to capture image data that includes at least one image of the property to be inventoried, whether the image is of the outside or inside of the property, and/or whether it is an image of the property itself, or an asset, or a structural feature of the property. The device of the user in that case would have a camera configured to capture the image data in response to the request. The software would then receive the image data from the device and process it by associating it with the property and/or location and/or asset being inventoried and for which the image date applies. The user can, in the future, request to see the image data stored by the software which preferably will be in a remote server on the “cloud”.

Certain users, such as developers or property managers or landlords, may use additional features in the software. For example, in multi-unit housing or in developments, each building may have the same washing machine for example, so this information can be inputted once and applied to all of the buildings in a unit of buildings. The software would have an option to link buildings into sets that can be modified simultaneously. For example, if a landlord owns eight units, and enters all 8 as separate properties into the software, the addition of locations and of assets can be done collectively for the set by choosing a particular location or “room” to be applicable to some or all of the properties of the landlord. Similarly, the assets can be applicable to one or more properties and/or locations on each unit. This would reduce the data entry requirements in situations where locations and/or assets are duplicative. This is useful for the landlords to do in order to keep track of loss or damage to property without burdensome data entry.

Other users, such as builders of new housing would conveniently be able to use the software since a lot of the units are similar and have the same items such as refrigerators, etc. Many units have similar layouts as builders often build from a pre-determined number of plans that may not vary significantly so the structural features would be the same. Builders can create these inventories efficiently and then transfer them to new buyers as a courtesy to new buyers so they don't have to do the work, and buyers would obtain access to the information via a link, or the information can be sent to them via email or otherwise as explained above. If the buyers have a subscription to the application software, the information can be uploaded into their account and they would not have to duplicate the work of the builder because they could just upload or transfer the information into their own accounts.

In the case of multi-family units which are similar, separate properties can be created in the system and information can be inputted into all of the properties at once. For example, if an apartment building has 150 apartments and they all have a kitchen, a landlord or builder can put in the name “kitchen” once and apply it to some or all of the units rather than having to put in the “kitchen” category 150 times one-by-one. The same is true for items such as washing machines, which may be the same in many or all of the units and this can be used to quickly input information on a large basis, and can include photos and receipts that are uploaded into the software one time and the photo or video or other document is associated with multiple assets on the list, such as the washing machine for each of the 150 units if it's the same. A location can have any name, even “miscellaneous” for items which do not have a permanent place in the house or just for convenience of the user.

In some cases, it may be useful for users not to have to type notes into the electronic device used to access the software. This may be for convenience, speed, or it could be that someone has bad eyesight and speaking into the system is more convenient. The software can also transliterate the verbal to the written so that the system is more efficient since someone can merely take a photo and dictate the information into the phone and this will be stored as an audio file and also transliterated into text. Even the approximate values of assets can be verbally “mentioned” by the user and this will be transliterated and put into the correct location in the database so that it can be used for calculating value of losses.

The present invention has many advantages. People have been advised to keep track of what they have in case of loss. The present system allows people to do this easily and safely, with safe cloud storage, and ability for easy updates. The software will allow people to easily determine if they have the right amount of insurance. This will protect apartment and condo owners for incidents which started in another person's home since there will be proof of what was damaged or lost. While the application software itself can be downloaded on a phone or computer, or accessed via the internet, some or all (preferably all) the information which is added such as locations, item descriptions, photos, videos, insurance papers, date stamping, recordation of what was send to whom and when, etc. is saved in a remote server on the “cloud” for safety and accessibility.

### Example 1

Homeowner or Renter

A user ran the software application of the present invention. The user was not registered and clicked on a link to sign up to use the software application. The user was then prompted to input demographic information, such as name, address of property, email and phone number, and whether they are a homeowner, renter, or insurance agent, or adjuster, or an estate attorney, or an appraisal firm, or “other”. The user named this property the “Primary Residence” so that this can be used to identify the property in the software. This information was saved on a secure remote server. The software application also prompted the user to input the number of bedrooms and bathrooms in the property, and the user inputted 4 bedrooms and 3 bathrooms, and this information was saved by the software application on a remote server. The user was then directed to the payment screen to choose between an annual or monthly payment, and to provide a method of payment. The user chose a monthly payment plan without any promotion code and put in credit card information, all of which was saved on the secure remote server. The software application next prompted the user to either upload saved photos of the exterior of the property or to take the pictures with a smart phone on which the software application is running for uploading into the software application in real time. The user clicked on the link for taking photos in real time and proceeded to take four photos of the property, one from each side at street level, which showed the entire property from each of the four sides. The photos were processed by the smart phone and the software application saved the photos on the remote secure server. The front photo was selected by the user to use as a visual identifier of the property next to the “Primary Residence” name of the property provided by the user for easy visual identification of this property in the software. The user was also prompted to either upload a saved photo or take a photo of the insurance policy for the property. The user chose to upload a saved version of the policy and this was saved on the remote server.

The user was then prompted to set up the “rooms”. First, the user was prompted to name each of the four rooms of the property. The user can name the bedrooms whatever the user wants as this is 100% customizable and can be, for example, a person's name, type of room, or even a category such as jewelry or electronics. The user named the four rooms Master Bedroom, Guest Bedroom, Pete's Bedroom, and House Jewelry.

The user then clicked on the Master Bedroom to add photos or videos by downloading saved photos or videos, or taking the photos or videos in real time. The user clicked on the option of taking photos in real time. The user took photos with a smart phone (which was used to access the software application) of 1) the bed; 2) the dresser; 3) a nightstand; and 4) a safe. The user added descriptions, approximate market values and tag words to each items to that the item can easily be found using the internal search engine of the application software (otherwise referred to as the software application). The descriptions were as follows: 1) king sized bed with wooden frame; 2) wood dresser; 3) wood nightstand with door; and 4) hardened steel safe with 3.0 cubic feet of storage space. The approximate market values were inputted as follows: 1) $350; 2) $200; 3) $100; and $480. The tag words which were added were: 1) king, bed, wood, frame; 2) dresser, wood, drawers; 3) wood, nightstand, door; and 4) safe, money, passports, combination. The tag words are searchable and the names of the items are searchable too as part of the tag words. At this time, the user did not elect to add additional photos or files such as warranties, receipts etc. Once the user completed the rooms, the user elected not to add new rooms. The user has the option of moving an item from one room to another by clicking on that item and the “move” key, to change rooms. At this time, the user did not elect to move any item from one room to another. If one or more items are sold by the user, they can simply be deleted. In this Example, the user chose not to delete any item at this time.

The user also added several items to the Master Bedroom for structural features. The user took pictures of 1) the floor; 2) the rug; and 3) a window. The user then put in descriptions as follows: 1) hardwood floor; 2) wool rug; and 3) double pane window. The approximate market values were entered as: 1) $1000; 2) $350; and 3) $500. The tag words which were included were: 1) floor; wood; hardwood; mahogany; 2) rug; wool; area rug; and 3) window; double paned; wood. The user then clicked on the “tabulate” tab and for the Master Bedroom the estimated value was listed as $2980.

At this time, additional rooms or items were not added. The information for the property can be modified or updated at a later time. At a later time, if there was a loss, for example, if a fire were to damage the rug and the king sized bed in the Master Bedroom, the user has the option of adding photos associated with the rug and the king sized bed to show the damage. The user can go into the software and identify an item as having been damaged or destroyed once this happens. The user in this case could take photos of the damaged rug and king sized bed and load those photos to the Master Bedroom and associate them with the rug and king sided bed, respectively. The user could have created a separate “room” for the damaged assets, such as a “damaged Master Bedroom”. The user then could send this information to the insurance company (or provide an access link) in conjunction with the claim for the damage. The user could select the items of bed and of rug. Then the user could click “share” for sharing with the insurance company. When prompted, the user can be asked for the cause of loss such as fire, water, wind, etc., who they will share the pictures with, and the email address of the person receiving the pictures and additional information such as a message or a reference claim number, or the completed claim form itself or proof of the claim submission. The can then be prompted whether they wanted the recipient to access a link with the information on the bed and rug or whether they wanted copies of the report to be sent, or both.

The software would then generate a report which includes a summary of who the insured was, who the insurance company is, the claim number for the insurance company, and a total value of damages for $2700. The report would include an itemized description of the items which were damaged and would include the pictures selected by the user with the bed, the damaged bed, the rug, and the damaged rug. The report would automatically be sent to the insurance company to the email indicated (or a link to the information, as selected by the user). The application software would save the report and the date(s) the report was created, sent or given access and to whom. The software then would have an indication that this shared list (rug and king sized bed) was sent and/or shared with the insurance company, how it was sent or shared, and when for the user to refer to this information later, if needed. The user could click on a “certificate” option on the software and a PDF certificate would be generated with a summary of who the insured was, who the insurance company is, the claim number for the insurance company, a total value of damages for $2700, the date the report was sent or access was provided, and to whom it was sent, as well as a copy of the report itself exactly as generated. This certificate would be available for the user to save or to print or to send to the insurance company. The certificate can be used as a way to prove to the insurance company what information was sent to them and when and for what purpose to expedite claim processing and to assist in the event of miscommunication or disputes.

### Example 2

Business Owner

A user ran the software application of the present invention. The user was not registered and clicked on a link to sign up to use the software application. The user was then prompted to input demographic information, such as name, business trade name, address of the business and business property, email and phone number, and whether they are an owner or representative of the business, insurance agent, or adjuster, or a business attorney, or an appraisal firm, or “other”. The user inputted that they are the owner of the business. This information was saved on a secure remote server. The software application also prompted the user to input the number of offices/rooms and bathrooms in the business property, and the user inputted large kitchen, 2 separate customer dining rooms, storage basement and 2 other rooms. This information was saved by the software application on a remote server. The user was then directed to the payment screen to choose between an annual or monthly payment, and to provide a method of payment. The user chose an annual payment plan with a promotion code and put in credit card information, all of which was saved on the secure remote server. The software application next prompted the user to either upload saved photos of the exterior of the property or to take the pictures with a smart phone on which the software application is running for uploading into the software application in real time. The user clicked on the link for taking photos in real time and proceeded to take four photos of the property, one from each side at street level, which showed the entire property from each of the four sides. The photos were processed by the smart phone and the software application saved the photos on the remote secure server. The front photo was selected by the user to use as a visual identifier of the property next to the “Restaurant” name of the property provided by the user for easy visual identification of this property in the application software. The user was also prompted to either upload a saved photo or take a photo of the insurance policy for the property. The user chose to take a photo of the policy and this was saved on the remote server.

The user was then prompted to set up the “rooms”. First, the user was prompted to name each room of the property. The user can name the rooms whatever the user wants as this is 100% customizable and can be, for example, a person's name, type of room, or even a category such as pots and pans or refrigeration units. The user named the rooms Kitchen, Dining Room 1, Dining Room 2, Waiting Area, Managers Office, Storage Basement, and Decor. This user operated a small restaurant. A separate business user at a law firm, for example, could have identified each office by attorney's name as an example of customizability.

The user then clicked on the Kitchen to add photos or videos by downloading saved photos or videos, or taking the photos or videos in real time. The user clicked on the option of taking a video in real time. The user took videos of the space used by the chefs, along with the many hanging pots used in the prep area. The user also took individual photos of specialty cook wear that was higher in value per piece. The user added descriptions, approximate values and tag words so each item can easily be found using the internal search engine. In connection with the video, the user put in the asset of “hanging pots”, and a value of $450, and tag words of pots, hanging, iron, four pots. In connection with the photos, which were two, the user created one asset for a “specialty mixer” and one for a “brick oven”, and put in a description for the mixer as a commercial multi-function mixer, a value of $1200, and tag words of mixer, food, chopping, and blender. For the “brick oven”, the user put in a description of high temperature wood fired brick oven, and a value of $4800, and tag words of oven, wood, brick. In the present software, an asset can be named, a description provided, a value provided, and tag words provided. It is possible to give just a name and skip the description and tag words, if desired. Additionally, the user can take additional photos to be added alongside any item to include warranties, receipts etc. The user chose not to do so here. As the user completes rooms, new rooms can be added at any time. If the user moves an item from one room to another, a simple click of that item, followed by a “move” key and that item(s), changes rooms. The user chose not to add new rooms or to move an item at this time. If an items is sold or replaced with new equipment by the user, they can simply delete it. The user chose not to delete an item at this time. There is no limit to the amount of photos or videos the user adds, however videos may be limited to 30 seconds each. The user did not chose to take additional photos or to add other documents. The user may want to take pictures of the structure of the business, including walls and baseboards, as well as the ceilings. This user chose not to take pictures or video of the structure at this time, or to add more assets to the other rooms at this time. The user then clicked on the “tabulate” tab and for the Kitchen and the estimated value was calculated as $6450. At the top of every photo and video, there may be identifiers showing the room it is in, the date it was added, and approximate value, for easy viewing.

As the user completes a property, they do not need to do anything else except update it as necessary. There will be potentially 1 email sent to the user monthly, with a theme and a reminder as not to inundate their business with junk emails. In the case of a national weather alert, an additional email will be sent only to those users in the areas that may be affected.

In the event of a loss, the user has a few options.

1) Create a new “room” and add photos of the damage
2) Add damage photos to the existing room showing damage

In either situation, the user will simply select the items to “share” with the insurance company. User will be asked for the cause of loss (fire, water, wind etc.), who they are sharing these pictures with, the email address of the person receiving the pictures and any additional message, such as referencing claim number. The permissions granted to the agent or third party (by the user), will allow them to sign on and view lost property exactly as user sent to them. The agent will not have access to the entire property if only a few items were selected. In the event of a catastrophic loss, all items can be shared, even if additional photos of damages are not available.

Shared lists will be stored separately on the user's page, so that they can be viewed and compared to the insurance company's documentation for accuracy. Users with multiple claims can also keep these lists separate and dated for easy review in the future. If the business owns or rents multiple properties, by viewing “my property information” they can add additional locations, using the same format as above.

Headings and subheadings, if any, are used for convenience only and do not limit the invention.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1) A method for generating and managing an inventory of assets, comprising:
receiving information identifying at least one building;
receiving information identifying at least one location inside or outside the building;
receiving identifying information with respect to one or more assets located in the at least one location of the building;
identifying a date or dates for the receipt of the information with respect to the one or more assets;
selecting one or more of the assets for creating a list; and
creating a list of the selected assets; and
computing an aggregate value of a plurality of the one or more assets on the list based on the identifying information with respect to the one or more assets.

2) The method according to claim 1, wherein receiving information with respect to one or more assets comprises receiving image data containing one or more images of the one or more assets.

3) The method according to claim 1, further comprising storing the information identifying the at least one building, the information identifying the at least one location, the information identifying the one or more assets, and the dates for receipt of the information with respect to the one or more assets.

4) The method according to claim 3, wherein the one or more computer readable memory storage devices comprise a remote server.

5) The method according to claim 1, further comprising providing a third party access to the list of selected assets.

6) The method according to claim 5, wherein providing a third party access to the list of selected assets comprises sending the third party information to enable remote access to the list and/or sending an electronic communication to the third party containing the list of selected assets.

7) The method according to claim 6, wherein when the third party is enabled for remote access to the list, the third party is enabled to utilize software located on the remote server to view the list of selected assets by location and/or to select a subset of the list of selected assets to create a sub-list of selected assets for viewing.

8) The method according to claim 1, further comprising providing a third party access to the list of selected assets for more than one user; and
showing the third party identifying information for the more than one user for selection by the third party of the user for which a respective list will be accessed.

9) A system for generating and managing an inventory of assets, comprising:
one or more processors; and
a machine readable medium including instructions stored therein, which when executed by the one or more of the processors, cause the processors to perform operations including:
receiving information identifying at least one building;
receiving information identifying at least one location inside or outside a building;
receiving identifying information with respect to one or more assets located in the at least one location of the building;
identifying a date or dates for the receipt of the information with respect to the one or more assets;
selecting one or more of the assets for creating a list;
creating a list of the selected assets; and
computing an aggregate value of a plurality of the one or more assets on the list based on the identifying information with respect to the one or more assets.

10) The system according to claim 9, wherein receiving information with respect to one or more assets comprises receiving image data containing one or more images of the one or more assets.

11) The system according to claim 9, wherein the operations performed by the one or more processors further include storing the information identifying at least one building, the information identifying the at least one location, the identifying information with respect to the one or more assets, and the date or dates for receipt of the information with respect to the one or more assets in one or more computer readable memory storage devices.

12) The system according to claim 11, wherein the one or more computer readable memory storage devices comprise a remote server.

13) The system according to claim 9, wherein the operations performed by the one or more processors further include providing a third party access to the list of selected assets.

14) The system according to claim 13, wherein providing a third party access to the list of selected assets comprises sending the third party information to enable access to the list remotely and/or sending an electronic communication to the third party containing the list of selected assets.

15) The system according to claim 14, wherein when the third party is enabled for remote access to the list, the third party is enabled to utilize software located on the remote server to view the list of selected assets by location and/or to select a subset of the list of selected assets to create a sub-list of selected assets for viewing.

16) The system according to claim 9, wherein the operations performed by the one or more processors further include providing a third party access to the list of selected assets for more than one user; and showing the third party identifying information for the more than one user for selection by the third party of the user for which a respective list will be accessed.

17) A method for claim submission for reimbursement from an insurance company, comprising:
receiving information identifying at least one building;
receiving information identifying at least one location inside or outside a building;
receiving identifying information with respect to one or more assets located in the at least one location of the building, the information with respect to the one or more assets comprising image data containing one or more images of the one or more assets;
identifying a date or dates for the receipt of the information with respect to the one or more assets;
selecting one or more of the assets for creating a list;
creating a list of the selected assets which includes at least some of the identifying information with respect to the one or more assets;
computing a value of a plurality of the assets on the list of selected assets based on the identifying information with respect to the one or more assets;
submitting a claim for reimbursement to an insurance company for the loss or damage of assets at least partially included on the list of the selected assets; and
sending to the insurance company, after the submission of the claim, an electronic communication containing identifying information for the claim which was submitted as well as the list of selected assets and/or containing information to enable remote access by the insurance company to the list of the selected assets on a remote server;
the method further comprising identifying a date for when the electronic communication was sent to the insurance company; and
storing the information identifying at least one building, the information identifying the at least one location, the information identifying the one or more assets, the date or dates for receipt of the information with respect to the one or more assets, the list of the selected assets, and the date on which the electronic communication was sent to the insurance company, in one or more computer readable memory storage devices.

18) The method according to claim 17, wherein identifying information for the one or more assets is searchable to find a particular asset as well as its location in the building, and wherein when the third party is enabled for remote access to the list, the third party is enabled to utilize software located on the remote server to view the list of selected assets by location and/or to select a subset of the list of selected assets to create a sub-list of selected assets for viewing, the method further comprising providing a third party access to the list of selected assets for more than one user; and
showing the third party identifying information for the more than one user for selection by the third party of the user for which a respective list will be accessed.

19) A system for claim submission for reimbursement from an insurance company for the loss or damage of assets at least partially included on a list of selected assets, comprising:
one or more processors; and
a machine readable medium including instructions stored therein, which when executed by the one or more processors, cause the processors to perform operations including:
receiving information identifying at least one building;
receiving information identifying at least one location inside or outside a building;
receiving identifying information with respect to one or more assets located in the at least one location of the building, the information with respect to the one or more assets comprising image data containing one or more images of the one or more assets;
identifying a date or dates for the receipt of the information with respect to the one or more assets;
selecting one or more of the assets for creating the list;
creating the list of the selected assets which includes at least some of the identifying information with respect to the one or more assets;
computing a value of a plurality of the assets on the list of selected assets based on the identifying information with respect to the one or more assets;
sending to the insurance company, after the submission of the claim, an electronic communication containing identifying information for the claim which was submitted as well as the list of selected assets and/or information to enable remote access by the insurance company to the list of the selected assets;
the method further comprising identifying a date for when the electronic communication was sent to the insurance company; and
storing the information identifying the at least one building, the information identifying the at least one location, the information identifying the one or more assets, the date or dates for receipt of the information with respect to the one or more assets, the list of the selected assets, and the date on which the electronic communication was sent to the insurance company, in one or more computer readable memory storage devices.

20) The system according to claim 19, wherein the operations performed by the one or more processors further include:
searching identifying information for the one or more assets to find a particular asset as well as its location in the building;
and wherein when the third party is enabled for remote access to the list, the third party is enabled to utilize software located on the remote server to view the list of selected assets by location and/or to select a subset of the list of selected assets to create a sub-list of selected assets for viewing, and wherein the operations performed by the one or more processors further include providing a third party access to the list of selected assets for more than one user; and
showing the third party identifying information for the more than one user for selection by the third party of the user for which a respective list will be accessed.
